(19) United States
(12) Patent Application Publication
(10) Pub. No.: US 2023/0239905 A1
(43) Pub. Date: Jul. 27, 2023

(54) WIRELESS COMMUNICATION SYSTEM, BASE STATION DEVICE AND WIRELESS COMMUNICATION METHOD

(71) Applicant: NIPPON TELEGRAPH AND TELEPHONE CORPORATION, Tokyo (JP)

(72) Inventors: Keita KURIYAMA, Musashino-shi, Tokyo (JP); Hayato FUKUZONO, Musashino-shi, Tokyo (JP); Masafumi YOSHIOKA, Musashino-shi, Tokyo (JP); Takafumi HAYASHI, Musashino-shi, Tokyo (JP)

(73) Assignee: NIPPON TELEGRAPH AND TELEPHONE CORPORATION, Tokyo (JP)

(21) Appl. No.: 18/008,874

(22) PCT Filed: Jun. 12, 2020
(86) PCT No.: PCT/JP2020/023235

§ 371 Date: Dec. 7, 2022

(51) Int. Cl. H04J 3/00; H04L 5/14

(52) U.S. Cl. CPC H04W 72/54; H04W 72/0446; H04L 5/14

(57) ABSTRACT

In a wireless communication system in which propagation delays between a plurality of terminal station devices and a base station device, which use time division multiplexing in a duplex operation system, are different from each other, at least one of the base station device or the terminal station devices includes a delay calculating unit that calculates the propagation delay for each of the terminal station devices, and the base station device includes a control unit that changes a frame configuration such that a standby time required for switching between an uplink frame and a downlink frame is shortened in accordance with the propagation delay for each of the terminal station devices. In accordance with this, a surplus standby time can be shortened, and a transmission capacity can be improved.

### TECHNICAL FIELD

The present invention relates to a technology for improving a transmission capacity in a case in which there is a propagation delay difference between abase station device and each of terminal station devices in a wireless communication system in which the base station device and a plurality of terminal station devices communicate with each other using time division multiplexing in a duplex operation system.

### BACKGROUND ART

In a wireless communication system using time division multiplexing (hereinafter, referred to as time division duplex (TDD)) in a duplex operation system, switching between a downlink signal (DL) from a base station device to a terminal station device and an uplink signal (UL) from the terminal station device to the base station device is necessary. At the time of switching between the DL and the UL, a guard time (a standby time) used for preventing a collision between signals is provided. Here, by providing a guard time longer than a propagation delay for a transmission distance between the DL and the UL, a collision between the DL and the UL can be avoided. For example, a method of determining a guard time in accordance with a predicted propagation delay may be considered (see NPL 1).

### CITATION LIST

### Non Patent Literature

[NPL 1] Fumiki UZAWA, Kazuhiko MITSUYAMA, and Tetsuomi IKEDA, “A study on TDD for bi-directional FPU”, ITE Annual Convention 2011, 13-10, 2011 (https://doi.org/10.11485/iteac.2011.0_13-10-1).

### SUMMARY OF THE INVENTION

### Technical Problem

However, in a case in which there is a difference in propagation delays of terminal station devices in a wireless communication system in which a base station device and a plurality of terminal station devices communicate with each other using time division multiplexing in a duplex operation system, a guard time is set in accordance with a terminal station device of which a propagation delay is long. At this time, a surplus standby time occurs in a terminal station device of which a propagation delay is relatively short among the plurality of terminal station devices. Particularly, in a case in which a propagation delay difference between a terminal station device of which a propagation delay is long and a terminal station device of which a propagation delay is short is large, there is a problem of the transmission capacity being decreased.

An object of the present invention is to provide a wireless communication system, abase station device, and a wireless communication method capable of improving a transmission capacity by shortening a surplus standby time by changing a frame configuration in a case in which there are differences between propagation delays of a plurality of terminal station devices using time division multiplexing in a duplex operation system.

### Means for Solving the Problem

According to the present invention, there is provided a wireless communication system in which propagation delays between a plurality of terminal station devices and a base station device, which use time division multiplexing in a duplex operation system, are different from each other, in which at least one of the base station device or the terminal station devices includes a delay calculating unit that calculates the propagation delay for each of the terminal station devices, and the base station device includes a control unit that changes a frame configuration of at least one of an uplink frame or a downlink frame such that a standby time required for switching between the uplink frame from the terminal station device to the base station device and the downlink frame from the base station device to the terminal station device is shortened in accordance with the propagation delay for each of the terminal station devices calculated by the delay calculating unit.

In addition, according to the present invention, there is provided a base station device performing wireless communication with a plurality of terminal station devices, of which propagation delays are different from each other, using time division multiplexing in a duplex operation system, the base station device including: a delay calculating unit that calculates the propagation delay for each of the terminal station devices; and a control unit that changes a frame configuration of at least one of an uplink frame or a downlink frame such that a standby time required for switching between the uplink frame from the terminal station device to the base station device and the downlink frame from the base station device to the terminal station device is shortened in accordance with the propagation delay for each of the terminal station devices calculated by the delay calculating unit.

In addition, according to the present invention, there is provided a wireless communication method in which propagation delays between a plurality of terminal station devices and a base station device, which use time division multiplexing in a duplex operation system, are different from each other, the wireless communication method including: performing a delay calculating process of calculating the propagation delay for each of the terminal station devices by using at least one of the base station device or the terminal station devices; and performing a control process of changing a frame configuration of at least one of an uplink frame or a downlink frame such that a standby time required for switching between the uplink frame from the terminal station device to the base station device and the downlink frame from the base station device to the terminal station device is shortened in accordance with the propagation delay for each of the terminal station devices calculated in the delay calculating process by using the base station device.

### Effects of the Invention

According to a wireless communication system, a base station device, and a wireless communication method according to the present invention, a transmission capacity can be improved by shortening a surplus standby time by changing a frame configuration in a case in which there are differences between propagation delays of a plurality of terminal station devices using time division multiplexing in a duplex operation system.

### BRIEF DESCRIPTION OF DRAWINGS

FIG. 1 is a diagram illustrating a configuration example of a wireless communication system that is common to embodiments.

FIG. 2 is a diagram illustrating a comparative example of a case in which a frame configuration is not changed.

FIG. 3 is a diagram illustrating an example of change of frame configurations of a UL and a DL.

FIG. 4 is a diagram illustrating an example of change of a frame configuration dedicatedly used for the DL.

FIG. 5 is a diagram illustrating a configuration example of a base station device and a terminal station device according to a first embodiment.

FIG. 6 is a diagram illustrating an example of a processing sequence of a wireless communication system according to the first embodiment.

FIG. 7 is a diagram illustrating a configuration example of a base station device and a terminal station device according to a second embodiment.

FIG. 8 is a diagram illustrating an example of a processing sequence of a wireless communication system according to the second embodiment.

FIG. 9 is a diagram illustrating an example of a processing sequence of a wireless communication system according to a third embodiment.

### DESCRIPTION OF EMBODIMENTS

Hereinafter, a wireless communication system, a base station device, and a wireless communication method according to embodiments of the present invention will be described with reference to the drawings.

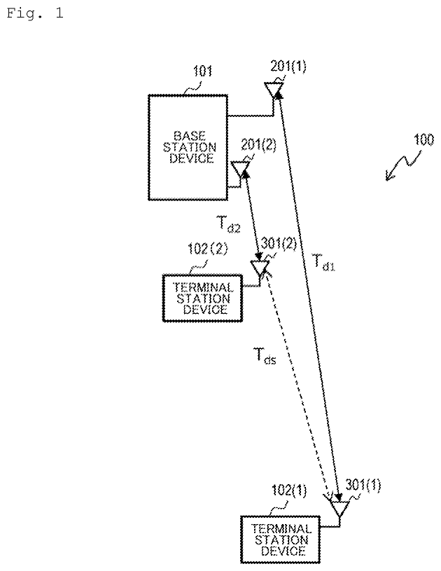

FIG. 1 is a diagram illustrating a configuration example of a wireless communication system 100 that is common to embodiments.

In FIG. 1, the wireless communication system 100 includes a base station device 101, a terminal station device 102(1), and a terminal station device 102(2). Here, when description common to the terminal station device 102(1) and the terminal station device 102(2) is performed, each of the terminal station devices will be represented as a terminal station device 102 by omitting “(number)” represented at the end of the reference sign. When a specific device is described, for example, the terminal station device will be represented as a terminal station device 102(1) by adding “number” to the end of the reference sign. Antennas 201(1) and 201(2) of the base station device 101, and an antenna 301(1) of the terminal station device 102(1) and an antenna 301(2) of the terminal station device 102(2) will be similarly described.

The base station device 101 includes a plurality of antennas 201 and performs communication with a plurality of terminal station devices 102 using multi user (MU)-multiple input multiple output (MIMO). In addition, in the wireless communication system 100, TDD is used in a duplex operation system, and a signal of a downlink (DL) and a signal of an uplink (UL) are time-divisionally multiplexed. Although an MU-MIMO system will be described in each of the embodiments described below, a similar effect can be acquired also in a case in which a propagation delay difference between the base station device 101 and the terminal station devices 102 is large in a point to multi point (P-MP) system or the like. For example, whether or not the propagation delay difference is large may be determined on the basis of whether or not the propagation delay difference is equal to or larger than a sub-frame length. Alternatively, whether or not the propagation delay difference is large may be determined on the basis of whether a transmission capacity is improved by a predetermined rate (for example, 5%) or more by using the transmission capacity as a criterion. In this way, in a case in which the propagation delay difference is large, change of a frame configuration described in each of the embodiments described below may be performed.

In FIG. 1, the base station device 101 performs wireless communication between the antenna 201(1) and the antenna 301(1) of the terminal station device 102(1), and a propagation delay at that time is T_{d1}. Similarly, the base station device 101 performs wireless communication between the antenna 201(2) and the antenna 301(2) of the terminal station device 102(2), and a propagation delay at that time is T_{d2}.

Here, a transmission distance between the base station device 101 and the terminal station device 102(1) is longer than a transmission distance between the base station device 101 and the terminal station device 102(2), and thus the propagation delay T_{d1} is longer than the propagation delay T_{d2}. At this time, a propagation delay difference Ids between the terminal station device 102(1) and the terminal station device 102(2) is given as in Equation (1).

T_{ds}=ABS(T_{d1}−T_{d2}) (1)

In Equation (1), ABS(x) represents an absolute value of x.

For example, in a case in which a difference between distances to the terminal station device 102(1) and the terminal station device 102(2) from the base station device 101 is 30 km, a propagation delay difference Ids between a propagation delay T_{d1} of the terminal station device 102(1) and a propagation delay T_{d2} of the terminal station device 102(2) is about 200 μsec in a round trip.

In a case in which the terminal station device 102(1) and the terminal station device 102(2) perform communication with the base station device 101 using TDD using frames of the same length, a guard time (GT) is set in accordance with the terminal station device 102(1) of which a propagation delay is long such that there is no collision between frames of the UL and the DL. In this case, a surplus standby time occurs between a frame of the UL and a frame of the DL in the terminal station device 102(2) of which the propagation delay is shorter than that of the terminal station device 102(1), and there is a problem in that the transmission capacity is decreased.

Thus, the wireless communication system 100 described in each of embodiments to be described below changes the frame configuration such that the transmission capacity is increased by shortening a surplus standby time of the terminal station device 102(2) of which the propagation delay is shorter than that of the terminal station device 102(1). More specifically, a payload length is extended such that the surplus standby time is shortened in a range in which a collision between the UL and the DL does not occur.

[Example of Frame Configuration of Comparative Example]

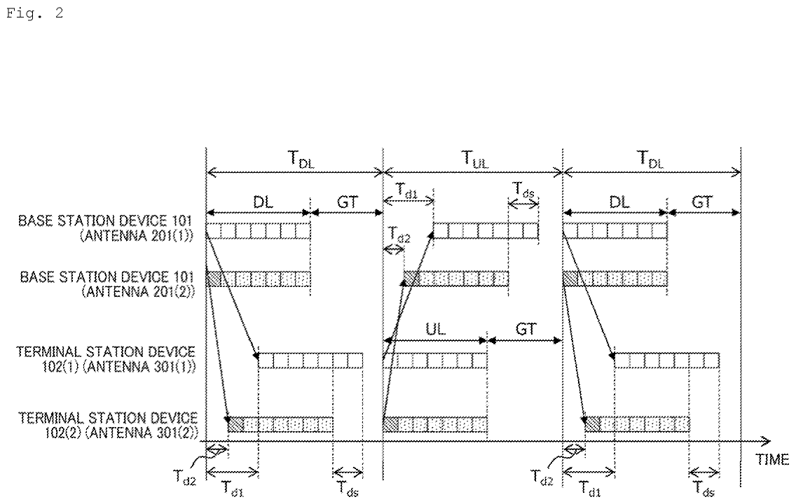

FIG. 2 is a diagram illustrating a comparative example of a case in which a frame configuration is not changed. In the comparative example, communication is performed without changing the frame configuration, and thus a surplus standby time occurs in communication of a side of which a propagation delay is shorter.

In FIG. 2, a base station device 101 communicates with each terminal station device 102 among a plurality of terminal station devices 102 for a frame of a DL and a frame of a UL using TDD.

In the example illustrated in FIG. 2, each of the frame of the DL and the frame of the UL is composed of 7 sub-frames including a header, and a period T_{DL} of the DL including a GT and a period T_{UL} of the UL including a GT are the same and are alternately repeated with a fixed period. Here, GTs are respectively set in accordance with transmission distances between the base station device 101 and a plurality of terminal station devices 102. For example, when a transmission distance of 50 km is assumed, a GT is set to a length of about 170 usec.

In the period T_{DL}, a frame of the DL transmitted from the antenna 201(1) of the base station device 101 is received by the terminal station device 102(1), and a propagation delay at that time is Tai. In addition, a frame of the DL transmitted from the antenna 201(2) of the base station device 101 is received by the terminal station device 102(2), and a propagation delay at that time is Tae. The propagation delay T_{d1} of the terminal station device 102(1) is longer than the propagation delay T_{d2} of the terminal station device 102(2), and thus a GT is set in accordance with the propagation delay Tai. More specifically, a time acquired by adding a margin to T_{d1} is set as the GT. For this reason, a surplus standby time from the end of a frame received by the terminal station device 102(2) to the end of a frame received by the terminal station device 102(1) occurs. In the example illustrated in FIG. 2, a propagation delay difference Ids acquired by excluding a margin from a period from the end of the frame received by the terminal station device 102(2) to the end of the GT corresponds to a standby time.

On the other hand, in the UL, a frame of the UL transmitted from the terminal station device 102(1) to the base station device 101 is received by the antenna 201(1) of the base station device 101, and a propagation delay at that time is T_{d1}. In addition, a frame of the UL transmitted from the terminal station device 102(2) to the base station device 101 is received by the antenna 201(2) of the base station device 101, and a propagation delay at that time is Tae. For this reason, a surplus standby time corresponding to a propagation delay difference Ids from the end of the frame of the terminal station device 102(2) received by the base station device 101 occurs.

In this way, in a case in which the frame configuration is not changed, in the terminal station device 102(2) of which a propagation delay is short, compared to the terminal station device 102(1) of which a propagation delay is long, a surplus standby time occurs between a frame of the DL and a frame of the UL, and there is a problem in that a transmission capacity is decreased.

[Example of Frame Configuration Common to Embodiments]

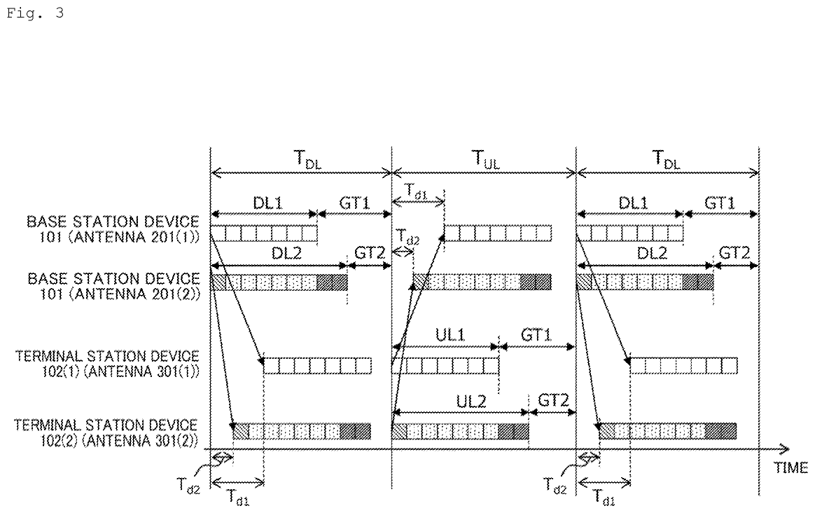

FIG. 3 is a diagram illustrating an example of change of frame configurations of a UL and a DL. Here, the example illustrated in FIG. 3 is a diagram similar to FIG. 2 of the comparative example and is an example of change of the frame configuration that is common to each of embodiments to be described below.

In FIG. 3, the base station device 101 performs communication with each terminal station device 102 among a plurality of terminal station devices 102 using TDD performing time division multiplexing of a frame of a DL and a frame of a UL.

In addition, similar to the comparative example illustrated in FIG. 2, a propagation delay T_{d1} between the antenna 201(1) of the base station device 101 and the terminal station device 102(1) is longer than a propagation delay Tae between the antenna 201(2) of the base station device 101 and the terminal station device 102(2).

In the example illustrated in FIG. 3, frame configurations of DL1 from the base station device 101 to the terminal station device 102(1) and UL1 from the terminal station device 102(1) to the base station device 101 are the same as those of the comparative example illustrated in FIG. 2 and are not changed. On the other hand, frame configurations of DL2 from the base station device 101 to the terminal station device 102(2) and UL2 from the terminal station device 102(2) to the base station device 101 are changed. In FIG. 3, the frame of the terminal station device 102(2) of which the propagation delay is short is extended to 9 sub-frames with respect to the frame (7 sub-frames) of the terminal station device 102(1) of which the propagation delay is long. In addition, communication data is stored in sub-frames, and thus extension of sub-frames is equivalent to extension of the payload length, and the transmission capacity is improved.

Here, a period T_{DL} of a downlink including a GT and a period T_{UL} of an uplink including a GT are the same as those of the comparative example illustrated in FIG. 2 and are alternately repeated with a fixed period. In other words, although the period of the DL and the period of the UL including GTs are the same as those of the comparative example illustrated in FIG. 2, the transmission capacity of each of the DL and the UL is improved from those of the comparative example illustrated in FIG. 2.

In this way, in the example illustrated in FIG. 3, by extending the payload lengths of the frames of DL2 and UL2 by shortening GT2 of the terminal station device 102(2), a standby time at the end of the frames of DL2 and UL2 of the terminal station device 102(2) can be decreased to be a minimum necessary. In accordance with this, the surplus standby time described with reference to FIG. 2 is shortened, and the payload length is extended, whereby an effect of the transmission capacity being improved can be acquired.

Here, the base station device 101 may change at least one of a modulation system and an encoding system to a system that is strong for data error in accordance with an increase in the transmission capacity according to extension of the payload lengths. In accordance with this, communication quality and reliability of the wireless communication system 100 are improved. A combination of a modulation system and an encoding system is given as a modulation and coding scheme (MCS) index. For example, when the MCS index becomes smaller, the transmission capacity becomes smaller, and the combination becomes stronger for data error. Thus, by decreasing the MCS index in correspondence with an increase in the transmission capacity according to extension of the payload lengths, the communication quality and the reliability can be improved without changing the transmission capacity.

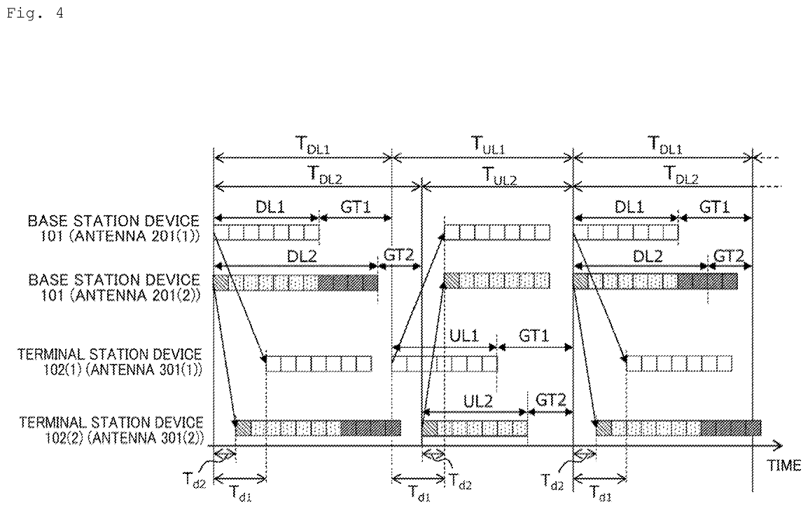

FIG. 4 is a diagram illustrating an example of change of a frame configuration dedicatedly used for the DL. Here, similar to the example illustrated in FIG. 3, the example illustrated in FIG. 4 is an example of change of a frame configuration common to the embodiments to be described below, and a base station device 101 communicates with a terminal station device 102(1) and a terminal station device 102(2). In FIG. 4, although an example in which a frame configuration dedicatedly used for a DL is changed is illustrated, a frame configuration that is dedicatedly used for a UL may be changed.

In FIG. 4, the base station device 101 performs communication of a frame of a DL and a frame of a UL with each terminal station device 102 among a plurality of terminal station devices 102 using TDD.

Similar to the examples illustrated in FIGS. 2 and 3, a propagation delay T_{d1} between the antenna 201(1) of the base station device 101 and the terminal station device 102(1) is longer than a propagation delay T_{d2} between the antenna 201(2) of the base station device 101 and the terminal station device 102(2).

In the example illustrated in FIG. 4, frame configurations of DL1 from the base station device 101 to the terminal station device 102(1), UL1 from the terminal station device 102(1) to the base station device 101, and UL2 from the terminal station device 102(2) to the base station device 101 are the same as those of the example illustrated in FIG. 2 and are not changed. On the other hand, in the example illustrated in FIG. 4, only a frame configuration of DL2 from the base station device 101 to the terminal station device 102(2) is changed. In the example illustrated in FIG. 4, the frame of DL2 of the terminal station device 102(2) of which a propagation delay is short is extended to 11 sub-frames with respect to the frame (7 sub-frames) of DL1 of the terminal station device 102(1) of which a propagation delay is long. As described with reference to FIG. 3, extension of sub-frames in which communication data is stored is equivalent to extension of the payload length, and the transmission capacity is improved.

Here, the frame of DL2 of the terminal station device 102(2) is longer than the frame of DL1 of the terminal station device 102(1), and a guard time GT2 of the terminal station device 102(2) is shorter than a guard time GT1 of the terminal station device 102(1).

In the case of FIG. 3, although both a period of (DL1+GT1) and a period of (DL2+GT2) are periods T_{DL} having the same length, a period T_{DL1} of (DL1+GT1) and a period T_{DL2} of (DL2+GT2) are different from each other in the case of FIG. 4. Similarly, in the case of FIG. 3, although both a period of (UL1+GT1) and a period of (UL2+GT2) are periods T_{UL} having the same length, a period T_{UL1} of (UL1+GT1) and a period T_{UL2} of (UL2+GT2) are different from each other in the case of FIG. 4. Here, the period T_{DL1} and the period T_{UL1} are alternately repeated with a fixed period. Similarly, the period T_{DL2} and the period T_{UL2} are alternately repeated with a fixed period. In addition, a sum of the period T_{DL1} and the period T_{UL1} is the same as a sum of the period T_{DL2} and the period T_{UL2}. In other words, although a sum of the period of a downlink and the period of an uplink including GT are the same as that of the example illustrated in FIG. 3, a transmission capacity acquired by combining the frame of the downlink and the frame of the uplink is improved similar to the example illustrated in FIG. 3. Particularly, a high effect for asymmetrical communication in which the transmission capacity of the downlink is larger than the transmission capacity of the uplink such as viewing of a stream-based content or the like can be acquired. In addition, although an example in which the frame configuration of the downlink is changed is illustrated in FIG. 4, the frame configuration of the uplink may be changed. In this case, for example, a high effect for asymmetrical communication in which the transmission capacity of the uplink is larger than the transmission capacity of the downlink such as upload of a captured image or the like can be acquired.

In this way, in the example illustrated in FIG. 4, by shortening GT2 of the terminal station device 102(2) and extending the payload length of the frame of only DL2, a surplus standby time at the end of the frame of DL2 of the terminal station device 102(2) can be shortened. At the same time, the period T_{DL2} of (DL2+GT2) is shortened in accordance with an increase in the period T_{DL2} of (DL1+GT1), and thus a standby time at the end of the frame of UL2 can be shortened. In accordance with this, in each of the embodiments to be described below, the payload length of the frame of DL2 is extended, and the surplus standby time of DL2 is shortened, whereby an effect of the transmission capacity being improved can be acquired.

In the example illustrated in FIG. 4, there is a period in which a part of the last sub-frame of the frame of DL2 of the terminal station device 102(2) overlaps a part of the first sub-frame of the frame of the UL1 of the terminal station device 102(1). However, an effect of the terminal station device 102(1) and the terminal station device 102(2) being separated and spatial multiplexing using MU-MIMO can be ignored.

### First Embodiment

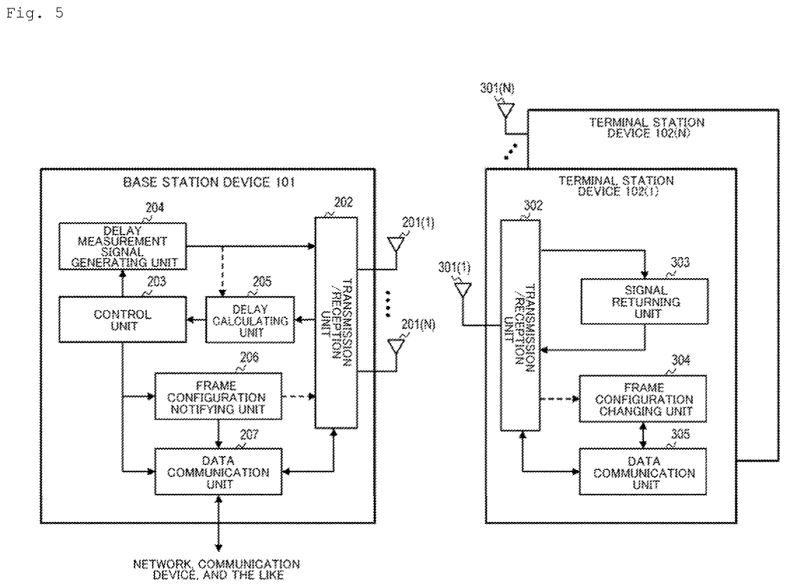

FIG. 5 is a diagram illustrating a configuration example of abase station device 101 and a terminal station device 102 according to a first embodiment. Although the configuration example of the terminal station device 102(1) is illustrated in FIG. 5, N (here, N is a positive integer) devices from a terminal station device 102(1) to a terminal station device 102(N) have the same configuration, and thus the terminal station device 102(1) will be referred to as a terminal station device 102. The wireless communication system 100 illustrated in FIG. 1 described above corresponds to a case of N=2 in FIG. 5.

(Configuration Example of Base Station Device 101)

In FIG. 5, the base station device 101 includes antennas 201(1) to 201(N), a transmission/reception unit 202, a control unit 203, a delay measurement signal generating unit 204, a delay calculating unit 205, a frame configuration notifying unit 206, and a data communication unit 207.

The antennas 201(1) to 201(N) convert high frequency signals output by the transmission/reception unit 202 into electromagnetic waves and transmits the electromagnetic waves to the terminal station device 102(1) to the terminal station device 102(N). To the contrary, the antennas 201(1) to 201(N) convert electromagnetic waves transmitted by the terminal station device 102(1) to the terminal station device 102(N) into high frequency signals and outputs the high frequency signals to the transmission/reception unit 202. In FIG. 5, the base station device 101 performs communication with N terminal station devices 102 using N antennas 201 from an antenna 201(1) to an antenna 201(N) by using MU-MIMO.

The transmission/reception unit 202 converts a transmission signal for each terminal station device 102 into a high frequency signal and outputs the converted high frequency signals to the N antennas 201 and converts a high frequency signal input from each of the N antennas 201 into reception signals from each terminal station device 102. In the example illustrated in FIG. 5, the transmission/reception unit 202 performs transmission/reception of signals with being spatially multiplexed such that signals of N streams corresponding to N terminal station devices 102 do not interfere with each other.

The control unit 203 is configured using a computer operating in accordance with a program stored in advance and performs overall control of the base station device 101. For example, the control unit 203 performs a process of measuring a propagation delay between the base station device 101 and the terminal station device 102 and changing a frame configuration such that the surplus standby time described with reference to FIG. 3 or FIG. 4 is shortened (corresponding to a control process). The measurement of a propagation delay is performed for each of N terminal station devices 102.

The delay measurement signal generating unit 204 generates a measurement signal determined in advance for measuring a propagation delay (referred to as a propagation delay measurement signal) in accordance with an instruction of the control unit 203 and outputs the generated propagation delay measurement signal to the transmission/reception unit 202. As the propagation delay measurement signal, for example, an M sequence sign or the like is used. Here, the propagation delay measurement signal may be transmitted before start of data communication or may be transmitted during data communication. In addition, a method for performing measurement as required during data communication by adding the propagation delay measurement signal to the start of the frame of communication data will be described below.

The delay calculating unit 205 calculates a propagation delay between the base station device 101 and each terminal station device 102 on the basis of information received from the N terminal station devices 102 (corresponding to a delay calculating process). Thereafter, the delay calculating unit 205 outputs the calculated propagation delay to the control unit 203. In the example illustrated in FIG. 5, the base station device 101 transmits a propagation delay measurement signal, and the terminal station device 102 returns and transmits the propagation delay measurement signal received from the base station device 101 to the base station device 101. The delay calculating unit 205 calculates a propagation delay by measuring a time until return of the propagation delay measurement signal after transmission thereof. For example, a time point at which the transmission/reception unit 202 has transmitted the M sequence sign and a time point at which the M sequence sign returned from the terminal station device 102 has been received are measured, and a difference between the reception time and the transmission time is calculated as a round-trip propagation delay. In addition, by taking a correlation with the same M sequence sign, the M sequence sign can be easily detected.

When the control unit 203 changes the frame configuration, the frame configuration notifying unit 206 performs a process of notifying the terminal station device 102 of information of the changed frame configuration. Here, as a method for notifying the terminal station device 102 of the frame configuration information, a method of storing frame configuration information in a header of communication data and transmitting the stored frame configuration information to the terminal station device 102 may be considered. Alternatively, a method of transmitting information of a frame configuration to the terminal station device 102 as independent control data before start of communication separately from communication data may be considered.

The data communication unit 207 converts communication data, for example, input from a network or a communication device connected to the outside into a transmission signal on the basis of the frame configuration output by the control unit 203 and transmits the converted transmission signal to each of the N terminal station devices 102. In addition, the data communication unit 207 converts a reception signal received from each of the N terminal station devices 102 into communication data and outputs the converted communication data to a network and a communication device connected to the outside. Here, as described above, in a case in which frame configuration information is transmitted to the terminal station device 102 with being stored in the header of communication data, the data communication unit 207 stores the frame configuration information output from the frame configuration notifying unit 206 in the header of the communication data.

In this way, the base station device 101 can shorten the surplus standby time described with reference to FIG. 3 or FIG. 4 by measuring a propagation delay for each of the N terminal station devices 102 and changing the frame configuration of communication data for each terminal station device 102.

(Configuration Example of Terminal Station Device 102)

In FIG. 5, the terminal station device 102(1) includes an antenna 301(1), a transmission/reception unit 302, a signal returning unit 303, a frame configuration changing unit 304, and a data communication unit 305. Here, as described above, the terminal station device 102(1) will be referred to as a terminal station device 102 as a representative of the N terminal station devices 102, and the antenna 301(1) will be referred to as an antenna 301.

The antenna 301 converts a high frequency signal output by the transmission/reception unit 302 into an electromagnetic wave, transmits the electromagnetic wave to the base station device 101, converts an electromagnetic wave transmitted by the base station device 101 into a high frequency signal, and outputs the high frequency signal to the transmission/reception unit 302. In this embodiment, the antenna 301 performs communication with N antennas 201 from an antenna 201(1) to an antenna 201(N) of the base station device 101 using MU-MIMO.

The transmission/reception unit 302 converts a transmission signal into a high frequency signal, outputs the high frequency signal to the antenna 301, and converts a high frequency signal input from the antenna 301 into a reception signal.

The signal returning unit 303 returns and outputs the propagation delay measurement signal received by the transmission/reception unit 302 to the transmission/reception unit 302.

The frame configuration changing unit 304 instructs the data communication unit 305 of a frame configuration used for transmission data and reception data on the basis of information of a frame configuration received from the base station device 101. Here, as described above, in a case in which the base station device 101 transmits frame configuration information with being stored in the header of communication data, the frame configuration changing unit 304 extracts the frame configuration information from reception data of the data communication unit 305 and instructs the data communication unit 305 of the frame configuration. Alternatively, in a case in which the base station device 101 transmits frame configuration information using control data other than communication data before start of communication or during communication, the frame configuration changing unit 304 receives the control data and instructs the data communication unit 305 of the frame configuration. In addition, the function of the frame configuration changing unit 304 may be included in the data communication unit 305.

The data communication unit 305 converts transmission data into a transmission signal on the basis of the frame configuration instructed from the frame configuration changing unit 304 and transmits the transmission signal from the transmission/reception unit 302 to the base station device 101. In addition, the data communication unit 305 converts a reception signal received by the transmission/reception unit 302 from the base station device 101 into reception data.

In this way, the terminal station device 102 returns back the propagation delay measurement signal received from the base station device 101 such that the base station device 101 can measure a round-trip propagation delay. Then, the terminal station device 102 is able to communicate with the base station device 101 for transmission data and reception data on the basis of the frame configuration notified from the base station device 101.

(Example of Processing Sequence)

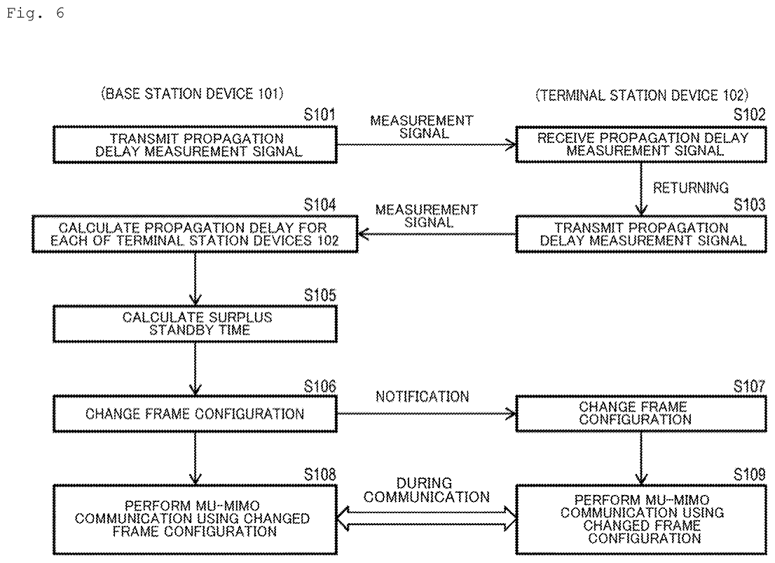

FIG. 6 illustrates an example of a processing sequence of the wireless communication system 100 according to the first embodiment. The process described with reference to FIG. 6 is performed by the base station device 101 and the terminal station device 102 described with reference to FIG. 5.

In Step S101, the delay measurement signal generating unit 204 of the base station device 101 generates a propagation delay measurement signal and transmits the generated propagation delay measurement signal from the transmission/reception unit 202 to the terminal station device 102.

In Step S102, the signal returning unit 303 of each terminal station device 102 receives the propagation delay measurement signal from the base station device 101.

In Step S103, the signal returning unit 303 of each terminal station device 102 returns and transmits the propagation delay measurement signal received from the base station device 101 to the base station device 101.

In Step S104, the delay calculating unit 205 of each base station device 101 receives the propagation delay measurement signal that is returned and transmitted from a plurality of terminal station devices 102 and calculates a propagation delay for each of the terminal station devices 102.

In Step S105, the control unit 203 of the base station device 101 calculates a surplus standby time on the basis of the propagation delay for each of the plurality of terminal station devices 102 acquired in Step S104. For example, in the case of FIG. 2, a propagation delay difference T_{ds} between the terminal station device 102(1) and the terminal station device 102(2) is calculated as an excessive standby time.

In Step S106, the frame configuration notifying unit 206 of the base station device 101 changes the frame configuration on the basis of the surplus standby time calculated in Step S105 and transmits information of the changed frame configuration to the terminal station device 102. The change of the frame configuration is performed for each of the plurality of terminal station devices 102. For example, in the case illustrated in FIG. 3 described above, the payload lengths of the frame of the DL and the frame of the UL of the terminal station device 102(2) are extended by lengths corresponding to two sub-frames. Alternatively, in the case of FIG. 4 described above, the payload length of the frame of the DL of the terminal station device 102(2) is extended by a length corresponding to four sub-frames.

In Step S107, the frame configuration changing unit 304 of each terminal station device 102 changes the frame configuration on the basis of the information of the frame configuration notified from the base station device 101.

In Step S108, the data communication unit 207 of the base station device 101 performs MU-MIMO communication with the plurality of terminal station devices 102 using the frame configuration changed in Step S106.

In Step S109, the data communication unit 305 of each terminal station device 102 performs MU-MIMO communication with the base station device 101 using the frame configuration changed in Step S107.

In this way, in the wireless communication system 100 according to the first embodiment, the base station device 101 can measure a propagation delay for each of the plurality of terminal station devices 102 and change the frame configuration such that the surplus standby time as described with reference to FIG. 3 or FIG. 4 is shortened.

In this way, the surplus standby time described with reference to FIG. 2 is shortened, and the payload length is extended, whereby an effect of the transmission capacity being improved can be acquired.

In addition, in FIGS. 5 and 6, although an example in which a round-trip propagation delay is measured on the base station device 101 side has been illustrated, by reversing the functions of the base station device 101 and the terminal station device 102, a propagation delay may be measured on the terminal station device 102 side. Alternatively, a propagation delay of each of the DL from the base station device 101 to the terminal station device 102 and the UL from the terminal station device 102 to the base station device 101 may be measured.

### Second Embodiment

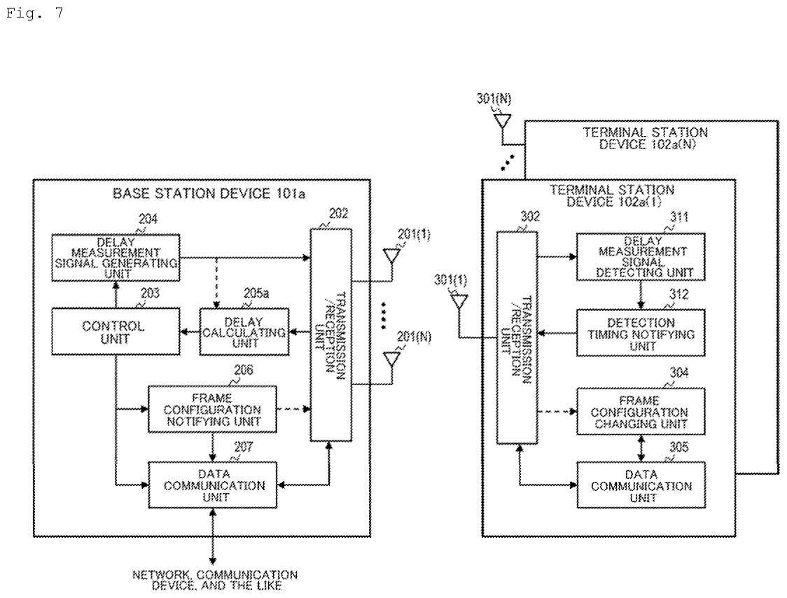

FIG. 7 is a diagram illustrating a configuration example of a base station device 101a and a terminal station device 102a according to a second embodiment. Here, the configuration of a wireless communication system 100a according to the second embodiment is the same as that of the wireless communication system 100 illustrated in FIG. 1, the base station device 101 illustrated in FIG. 1 can be substituted with the base station device 101a, and the terminal station device 102 can be substituted with the terminal station device 102a.

In FIG. 7, although the configuration example of the terminal station device 102a(1) is illustrated, N (here, N is a positive integer) devices from the terminal station device 102a (1) to the terminal station device 102a (N) have the same configuration and will be described as the terminal station device 102a. In addition, similar to the example illustrated in FIG. 5, description will be similarly presented also for the antenna 301(1) to the antenna 301(N) of the terminal station device 102a and the antenna 201(1) to the antenna 201 of the base station device 101a. FIG. 1 described above corresponds to the case of N=2 in FIG. 7.

(Configuration Example of Base Station Device 101a)

In FIG. 7, the base station device 101a includes N antennas 201, a transmission/reception unit 202, a control unit 203, a delay measurement signal generating unit 204, a delay calculating unit 205a, a frame configuration notifying unit 206, and a data communication unit 207.

Here, the configuration of the base station device 101a is basically the same as that of the base station device 101 according to the first embodiment, and thus the delay calculating unit 205a of which an operation is different will be described.

The delay calculating unit 205a receives information about a detection timing of a propagation delay measurement signal, which has been transmitted from the base station device 101a, in the terminal station device 102a from the terminal station device 102a. The information of a detection timing, for example, is information of a detection time of a propagation delay measurement signal, which has been transmitted from the base station device 101a, in the terminal station device 102a. In this case, it is assumed that time synchronization has been established between the base station device 101a and the terminal station device 102a using a global positioning system (GPS) or the like. On the other hand, the delay calculating unit 205a can acquire information of a transmission time of a propagation delay measurement signal from the delay measurement signal generating unit 204. Then, the delay calculating unit 205a calculates a difference between a reception time and a transmission time notified from the plurality of terminal station devices 102a as a propagation delay of each of the terminal station devices 102a (corresponding to a delay calculation process). The propagation delay calculated by the delay calculating unit 205a is output to the control unit 203. The control unit 203 changes the frame configuration on the basis of the propagation delay of each terminal station device 102a calculated by the delay calculating unit 205a.

A subsequent process is the same as that of the base station device 101 and the terminal station device 102 according to the first embodiment.

In this way, the base station device 101a measures a propagation delay for each of the N terminal station devices 102a and changes the frame configuration of communication data, thereby being able to shorten a surplus standby time described with reference to FIG. 3 or FIG. 4.

(Configuration Example of Terminal Station Device 102a)

The terminal station device 102a includes an antenna 301, a transmission/reception unit 302, a frame configuration changing unit 304, a data communication unit 305, a delay measurement signal detecting unit 311, and a detection timing notifying unit 312.

Here, processes of the antenna 301, the transmission/reception unit 302, the frame configuration changing unit 304, and the data communication unit 305 are the same as those of the terminal station device 102 according to the first embodiment, and thus duplicate description will be omitted. The terminal station device 102a according to the second embodiment does not have the signal returning unit 303 of the terminal station device 102 according to the first embodiment but includes the delay measurement signal detecting unit 311 and the detection timing notifying unit 312.

The delay measurement signal detecting unit 311 detects a propagation delay measurement signal received by the transmission/reception unit 302 and outputs a detection timing (a detection time point) to the detection timing notifying unit 312.

The detection timing notifying unit 312 transmits information of the detection timing input from the delay measurement signal detecting unit 311 from the transmission/reception unit 302 to the base station device 101a. Here, the detection timing notifying unit 312 may transmit information of the detection timing to the base station device 101 with being stored in the header of communication data or may transmit information of the detection timing to the base station device 101 using control data other than the communication data.

Thus, the terminal station device 102a notifies the base station device 101a of the detection timing of the propagation delay measurement signal received from the base station device 101a such that the base station device 101a can measure a propagation delay. Then, the terminal station device 102a transmits/receives communication data to/from the base station device 101a on the basis of the frame configuration notified from the base station device 101a.

(Example of Processing Sequence)

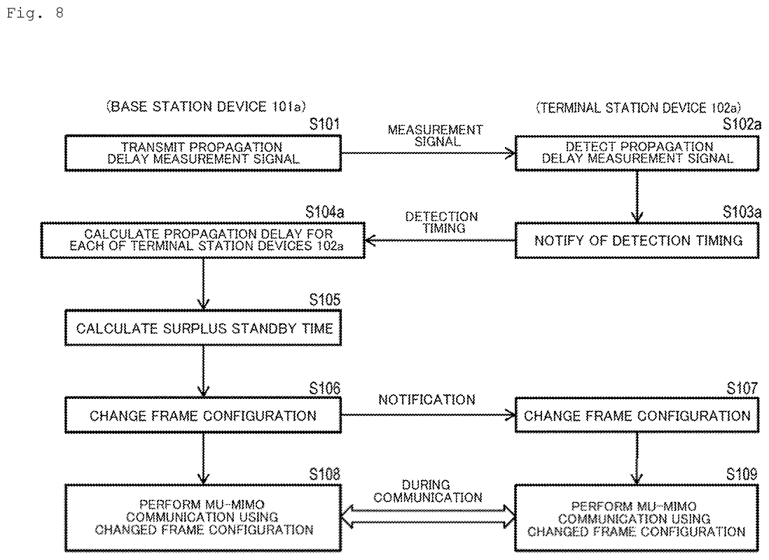

FIG. 8 is a diagram illustrating an example of a processing sequence of the wireless communication system 100a according to the second embodiment. The process described with reference to FIG. 8 is performed by the base station device 101a and the terminal station device 102a described with reference to FIG. 7.

In FIG. 8, processes of Step S101 and Steps S105 to S109 are the same as those of steps of the same reference signs described with reference to FIG. 6, and duplicate description will be omitted.

In Step S102a, the delay measurement signal detecting unit 311 of each terminal station device 102a detects a propagation delay measurement signal received from the base station device 101a and outputs a detection timing (a detection time point) to the detection timing notifying unit 312.

In Step S103a, the detection timing notifying unit 312 of each terminal station device 102a transmits information of the detection timing input from the delay measurement signal detecting unit 311 to the base station device 101a.

In Step S104a, the delay calculating unit 205a of the base station device 101a receives the information of the detection timing from the plurality of terminal station devices 102a and calculates a propagation delay for each terminal station device 102a.

Thereafter, the processes of Step S105 to Step S109 are performed similar to those illustrated in FIG. 6, and the base station device 101a changes the frame configuration on the basis of the surplus standby time calculated for each of the terminal station devices 102a. Then, similar to the base station device 101 according to the first embodiment, the base station device 101a notifies the terminal station device 102a of the change of the frame configuration and performs MU-MIMO communication with the terminal station device 102a using the changed frame configuration.

In this way, in the wireless communication system 100a according to the second embodiment, the base station device 101a measures a propagation delay for each of the plurality of terminal station devices 102a and changes the frame configuration such that the surplus standby time as described with reference to FIG. 3 or FIG. 4 is shortened.

In accordance with this, the surplus standby time described with reference to FIG. 2 is shortened, and the payload length is extended, whereby an effect of the transmission capacity being improved can be acquired.

Here, in the second embodiment, although an example in which a propagation delay is calculated by transmitting a propagation delay measurement signal before start of data communication is illustrated, a propagation delay may be measured at any time during data communication by storing the propagation delay measurement signal in the header of a frame of the communication data.

In addition, in FIGS. 7 and 8, although an example in which a propagation delay of the DL is measured by transmitting a propagation delay measurement signal from the base station device 101a to the terminal station device 102a is illustrated, a propagation delay of a UL may be measured by transmitting a propagation delay measurement signal from the terminal station device 102a to the base station device 101a. Alternatively, propagation delays of both the DL and UL may be measured by transmitting propagation delay measurement signals from the base station device 101a and the terminal station device 102a.

### Third Embodiment

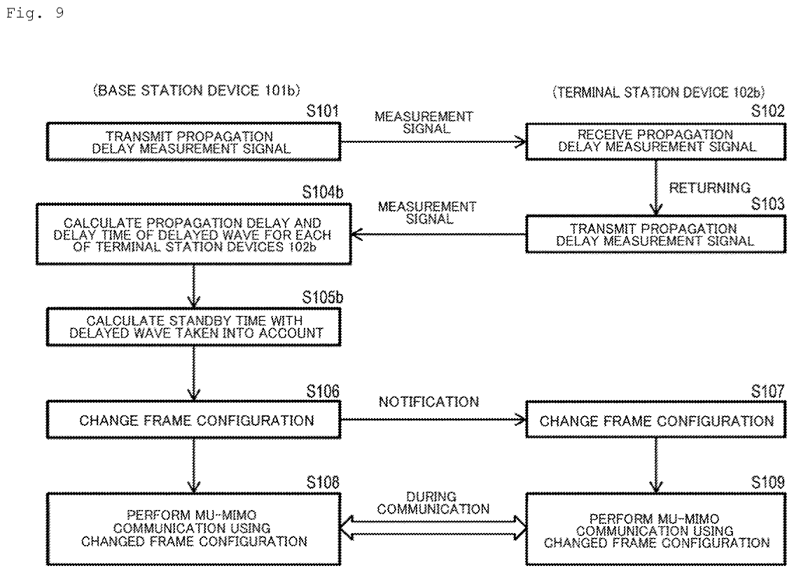

FIG. 9 is a diagram illustrating an example of a processing sequence of a wireless communication system 100b according to a third embodiment.

The wireless communication system 100b according to the third embodiment is the same as the wireless communication system 100 illustrated in FIG. 1, and the base station device 101 and the terminal station device 102 illustrated in FIG. 1 can be substituted with a base station device 101b and a terminal station device 102b.

Although the base station device 101b and the terminal station device 102b according to the third embodiment are composed of blocks that are basically the same as those according to the first embodiment, operations of a delay calculating unit 205 and a control unit 203 are slightly different from those according to the first embodiment. In the third embodiment, the delay calculating unit 205 illustrated in FIG. 5 is substituted with a delay calculating unit 205b, and the control unit 203 is substituted with a control unit 203b in description.

In the third embodiment, a correlation of propagation delay measurement signals communicated between the base station device 101b and the terminal station device 102b is calculated, and not only a propagation delay but also a delay time of a delayed wave according to multiple paths and the like is acquired. Thereafter, the base station device 101b changes the frame configuration with the delay time of the delayed wave taken into account. More specifically, the base station device 101b changes the frame configuration such that not ends of frames of a direct wave but ends of frames of a delayed wave do not collide with each other at the time of switching between the DL and the UL.

In FIG. 9, processes of Step S101 to Step S103 and processes of Step S106 to Step S109 are the same as those of steps of the same reference signs described with reference to FIG. 6, and thus duplicate description will be omitted. Here, processes that are different from those illustrated in FIG. 6 will be described.

In Step S104b, the base station device 101b receives a propagation delay measurement signal that is returned and transmitted from the plurality of terminal station devices 102b and calculates a propagation delay for each terminal station device 102b. In addition, the base station device 101b acquires a delay time of a delayed wave with which a propagation delay measurement signal received from the plurality of terminal station devices 102b is received with a delay due to a multi-path and the like. The delay time can be acquired by taking a sliding correlation of propagation delay measurement signals received by the base station device 101b.

In Step S105b, the base station device 101b calculates a surplus standby time on the basis of the propagation delay and the delay time of the delayed wave for each of the plurality of terminal station devices 102b acquired in Step S104b. For example, in the case of FIG. 2, although the propagation delay difference T_{ds} between the terminal station device 102b(1) and the terminal station device 102b(2) is calculated as an excessive standby time, a surplus standby time is calculated with the delay time of the delayed wave taken into account. More specifically, the base station device 101b calculates a surplus standby time not from the end of a frame of a direct wave but from the end of a frame of a delayed wave. In addition, in a case in which there are a plurality of delayed waves, for example, the delayed wave described above may be limited to a first delayed wave that is considered to have a relatively strong influence or the like. Alternatively, levels of delayed waves may be measured, and only delayed waves of which levels are equal to or higher than a threshold set in advance may be taken into account.

Thereafter, processes of Step S106 to Step S109 are performed similar to those illustrated in FIG. 6, and the base station device 101b changes the frame configuration on the basis of the surplus standby time calculated for each of the terminal station devices 102b. Then, the base station device 101b notifies the terminal station device 102b of the change of the frame configuration and performs MU-MIMO communication with the terminal station device 102b using the changed frame configuration.

In this way, in the wireless communication system 100b according to the third embodiment, the base station device 101b calculates a surplus standby time by measuring a propagation delay and a delay time of the delayed wave for each of the plurality of terminal station devices 102b and changes the frame configuration.

In accordance with this, the surplus standby time described with reference to FIG. 2 is shortened, and the payload length is extended, whereby an effect of the transmission capacity being improved can be acquired.

As described above, according to a wireless communication system, a base station device, and a wireless communication method according to the present invention, the frame configuration is changed in a case in which a propagation delay difference between the plurality of terminal station devices using time division multiplexing in a duplex operation system is large, thereby being able to shorten a surplus standby time and improve the transmission capacity.

In addition, the present invention can be applied to any system in which there are a plurality of terminal station devices, and a propagation delay difference occurs regardless of a communication system thereof. In each of the embodiments described above, although the MU-MIMO system employing TDD as a duplex operation system has been described as an example, the present invention can be applied also to an SISO system performing P-MP communication and the like.

In addition, the processes performed by the delay calculating unit 205 (the delay calculating unit 205a) and the control unit 203 of the base station device 101 (the base station device 101a and the base station device 101b) according to each of the embodiments described with reference to FIGS. 5 to 9 can be realized also using a computer and a program. The program may be recorded on a recording medium such as a memory and mounted in the base station device 101 or may be provided through a network.

### REFERENCE SIGNS LIST

100, 100a, 100b Wireless communication systema
101, 101a, 101b Base station device
102, 102a, 102b Terminal station device
201 Antenna
202 Transmission/reception unit
203 Control unit
204 Delay measurement signal generating unit
205, 205a Delay calculating unit
206 Frame configuration notifying unit
207 Data communication unit
301 Antenna
302 Transmission/reception unit
303 Signal returning unit
304 Frame configuration changing unit
305 Data communication unit
311 Delay measurement signal detecting unit
312 Detection timing notifying unit

1. A wireless communication system in which propagation delays between a plurality of terminal station devices and a base station device, which use time division multiplexing in a duplex operation system, are different from each other,
wherein at least one of the base station device or the terminal station devices includes a delay calculating unit that calculates the propagation delay for each of the terminal station devices, and
wherein the base station device includes a control unit that changes a frame configuration of at least one of an uplink frame or a downlink frame such that a standby time required for switching between the uplink frame from the terminal station device to the base station device and the downlink frame from the base station device to the terminal station device is shortened in accordance with the propagation delay for each of the terminal station devices calculated by the delay calculating unit.

2. The wireless communication system according to claim 1, wherein the control unit extends a payload length of at least one of the uplink frame or the downlink frame of the terminal station device of which the propagation delay is short among the plurality of terminal station devices.

3. The wireless communication system according to claim 2, wherein the control unit changes at least one of a modulation system or an encoding system in accordance with an increase in a transmission capacity according to the extension of the payload length.

4. A base station device performing wireless communication with a plurality of terminal station devices, of which propagation delays are different from each other, using time division multiplexing in a duplex operation system, the base station device comprising:
a delay calculating unit that calculates the propagation delay for each of the terminal station devices; and
a control unit that changes a frame configuration of at least one of an uplink frame or a downlink frame such that a standby time required for switching between the uplink frame from the terminal station device to the base station device and the downlink frame from the base station device to the terminal station device is shortened in accordance with the propagation delay for each of the terminal station devices calculated by the delay calculating unit.

5. The base station device according to claim 4, wherein the control unit extends a payload length of at least one of the uplink frame or the downlink frame of the terminal station device of which the propagation delay is short among the plurality of terminal station devices.

6. A wireless communication method in which propagation delays between a plurality of terminal station devices and a base station device, which use time division multiplexing in a duplex operation system, are different from each other, the wireless communication method comprising:
performing a delay calculating process of calculating the propagation delay for each of the terminal station devices by using at least one of the base station device or the terminal station devices; and
performing a control process of changing a frame configuration of at least one of an uplink frame or a downlink frame such that a standby time required for switching between the uplink frame from the terminal station device to the base station device and the downlink frame from the base station device to the terminal station device is shortened in accordance with the propagation delay for each of the terminal station devices calculated in the delay calculating process by using the base station device.

7. The wireless communication method according to claim 6, wherein, in the control process, a payload length of at least one of the uplink frame or the downlink frame of the terminal station device of which the propagation delay is short among the plurality of terminal station devices is extended.
